(19) United States
(12) Patent Application Publication
(10) Pub. No.: US 2004/0049731 A1
(43) Pub. Date: Mar. 11, 2004

(54) Ordered card manufacturing system

(76) Inventor: Nobuaki Suzuki, Soka-shi (JP)

Correspondence Address: Nobuaki Suzuki, 2110-10 Sezaki-cho, Soka-shi, 340-0022, JP

(21) Appl. No.: 10/234,372

(22) Filed: Sep. 5, 2002

(51) Int. Cl. G06F 17/24; G06F 17/21; G06F 17/00

(52) U.S. Cl. 715/505; 715/517

(57) ABSTRACT

An ordered card manufacturing system includes a transmitting equipment reads and transmit an application form; a receiving equipment receives application information from the transmitting equipment; a management server including a database for image data which manages an image code corresponding to specific image patterns including a design and a pattern arranged on an ordered card; a customer database; and an order management database which manages a data for transmission replaced image pattern data to the image code after creating a layout data which manufactured the layout of the ordered card based on the information from a customer; a manufacture terminal for the ordered card installed into the management server connectably; a terminal for printing connected to the management server, having the database for image data and means for checking, receiving a data for transmission from the order management database of the management server and displaying a printing layout picture based on a layout data which is changed from the image code to the image pattern; and a printing machine connected to the terminal for printing.

### BACKGROUND OF THE INVENTION

This invention relates to a system for manufacturing an ordered card including individual specification information such as a Christmas card, a New Year's greeting card, an in-mourning postcard, invitation card and a card, etc. and company specification information such as commencement-of-business guidance, direct mail, and so on.

In the conventional system for manufacturing the ordered card including individual specification information and company specification information such as a Christmas card, New Year's greeting card, an in-mourning postcard, invitation card, a card or the like, a design pattern, a document form, and the personal information for printing are received with the application form for mailing from a shop receptionist or a house, and the application is passed to the manufacture center by electrical transmission or mailing, and the layout is done by the operator at the manufacture center and it is printing with the special printer. After that, printed matter is delivered to the shop and then given it to the customer.

As a system passed to a customer on the same day, the receptionist shops have a facsimile and the data terminal therein, and they send facsimile the application form to the manufacture center, and then the operator manufactures only the character layout except a design pattern and the character layout data is transmitted from the manufacture center to the terminal in the receptionist shop, and the operator in the receptionist shop work to print in the special card which already printed the design pattern beforehand prepared based on the data.

However, in the former system, it spends a time and it is impossible to have delivered on the day that is received from the request

In the latter system since it is necessary to prepare many postcards printed beforehand, it is necessary to secure the storage space in the store. Moreover, about the handling of a postcard with a stamp, the postcards that are not used become useless, and the postcards that are in stock causes to lose as it is.

In addition to these systems, it is considered that the data which contained design data arrange the layout in the manufacture center, however, since the amount of data including the design data used for printing is heavier than that of the character data, transmission and reception took time, and the charge of communication increased and it has a limit in the quantity to be processed on a day.

### SUMMARY OF THE INVENTION

Accordingly, it is an object of the present invention provide in system that the database for image data is used in the terminal for printing and a management server so that the image data contained many amounts of data is changed into the image code contained lighter data and the image code is transmitted, and then an exchange of data can be performed efficiently. It is another object of the present invention provide in system that it is unnecessary to prepare the postcard printed the design beforehand. It is still object of the present invention provide in system that can improve the number of stock, storage place and loss caused by unnecessary stock.

The novel features which are believed to be characteristic of the invention, both as to its organization and method of operation, together with further objects and advantages thereof, are described below with reference to the accompanying drawings in which a presently preferred embodiment of the invention is illustrated as an example.

It is to be expressly understood, however, that the drawings are for the purpose of illustration and description only, and are not intended as a definition of the limits of the invention.

### BRIEF DESCRIPTION OF THE DRAWINGS

FIG. 1 is an explanation view of a system showing a first embodiment of the present invention;

FIG. 2 is an explanation view of a database for image data of the present invention;

FIG. 3 is an explanation view of a database for data pattern of the present invention;

FIG. 4 is an explanation view of an application sheet of the present invention;

FIG. 5 is an explanation view of a work screen;

FIG. 6 is an explanation view when in use of the present invention;

FIG. 7 is an explanation view showing another embodiment of the present invention;

FIG. 8 is an explanation view showing another embodiment of the present invention; and

FIG. 9 is a sectional view showing another embodiment of the present invention.

### DETAILED DESCRIPRION OF THE PREFERRED EMBODIMENT

Preferred embodiments of the present invention are described in more detail below referring to the accompanying drawings.

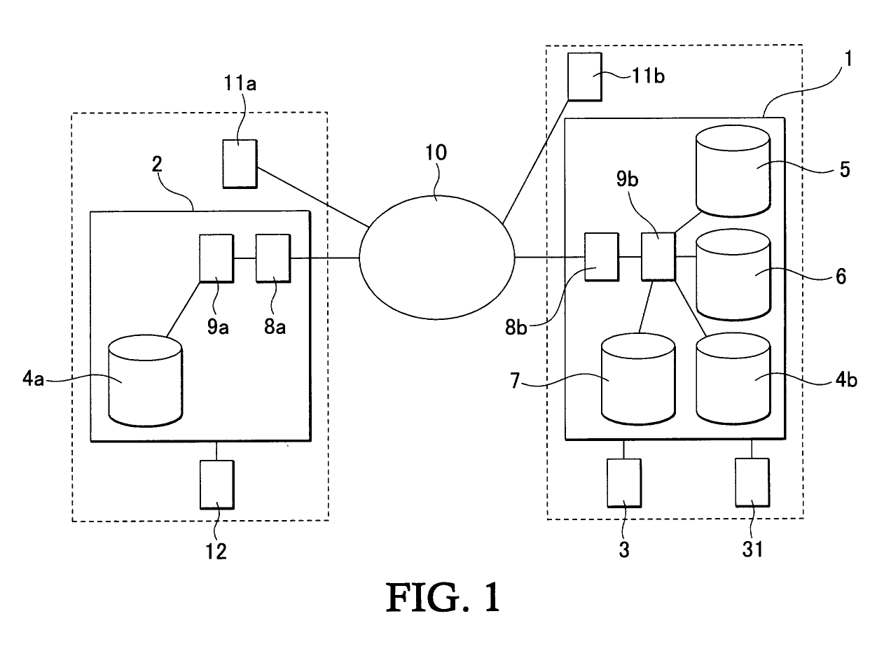

An understanding of the present invention may be best gained by reference FIGS. 1 to 6. FIG. 1 illustrates the configuration figure of the system in this invention. A facsimile 10 as transmitting equipment which reads and transmits to a customer's application form 12 and a terminal 1 for printing are furnished in a receptionist store in the state of being connectable with the public line network 7. The terminal 1 for printing includes a transceiver part 8, a database 4 for image data, a database 6 for text pattern, a control part 9, a monitor, a keyboard, etc. Moreover, the printer 11 as a printing machine is connected to the terminal 1.

The Facsimile 10 and a management server 2 are furnished to the manufacture center in the state of being connectable with the public line network 7. The management server 2 includes the transceiver part 8, the database 4 for image data, the database 6 for text pattern, and the control part 9. Moreover, a manufacture terminal 3 is connected to the management server 2. In addition, a scanner 21 is connected to the manufacture terminal 3 and may connect with the management server 2 in addition to manufacture terminal 3.

The database 4 for image data and the database 6 for text pattern are common to the terminal 1 for printing and the manufacture terminal 3.

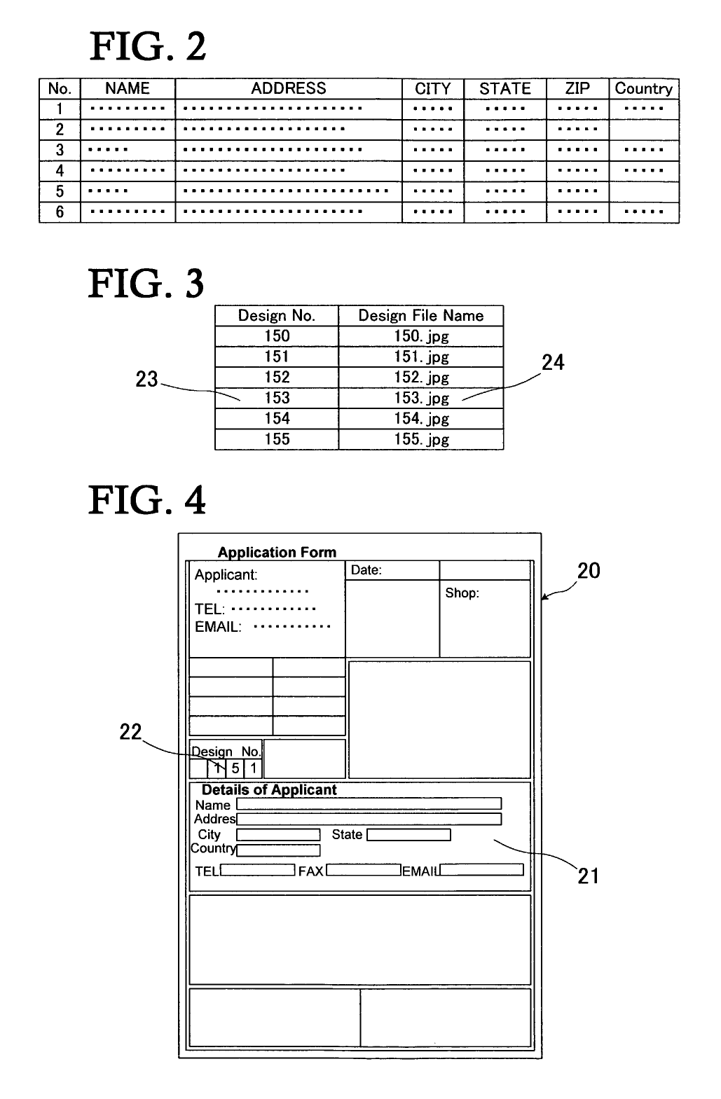

As illustrated in FIG. 2, an image pattern code is lotted to the various file names 16 for image pattern and is managed with the database 4 for image data. Each image pattern file is related with the corresponding file name 16 for image pattern.

As illustrated in FIG. 3, in the database 6 for data pattern, the data pattern code is lotted to the various text patterns. The text pattern is specified to the contents of a text and arrangement.

An order management database 5 of the management server 2 manages and storages the data for transmission that is replaced image pattern data to the image code 15 after the layout data that manufactured the layout of an ordered card.

The service that manufactures the greeting card as an ordered card, New Year's greeting card in this embodiment is mentioned as an example and is explained as follows.

At first, as illustrated in FIG. 4, a customer indicates individual specification information including the address, name, telephone number, fax number, e-mail address, and so on into the individual specification information entry column 13 and selects image designing and the text pattern 18 which the customer wishes in the image pattern specification column 14 with an application form 12. When the customer selects the image designing and text pattern 18, the samples of the various codes that correspond to the various image designs and the text pattern 18 are prepared so that the customer enters the codes in the application form 12. Moreover, the application form 12 has the other required item columns including an order number column, handling store column and so on, these columns are managed either the store person fills in the blank or the columns are filled or printed. After that, the application form 12 filled is transmitted to the manufacture center by the facsimile 10.

After the manufacture center receives the application form 12 by facsimile 10, it is outputted to paper. Then application form 12 is scanned with the scanner 21 and the manufacture terminal 3 using a manufacture program performs manufacturing. In addition, in the manufacture program, the contents of the application form 12 are inputted using an OCR function.

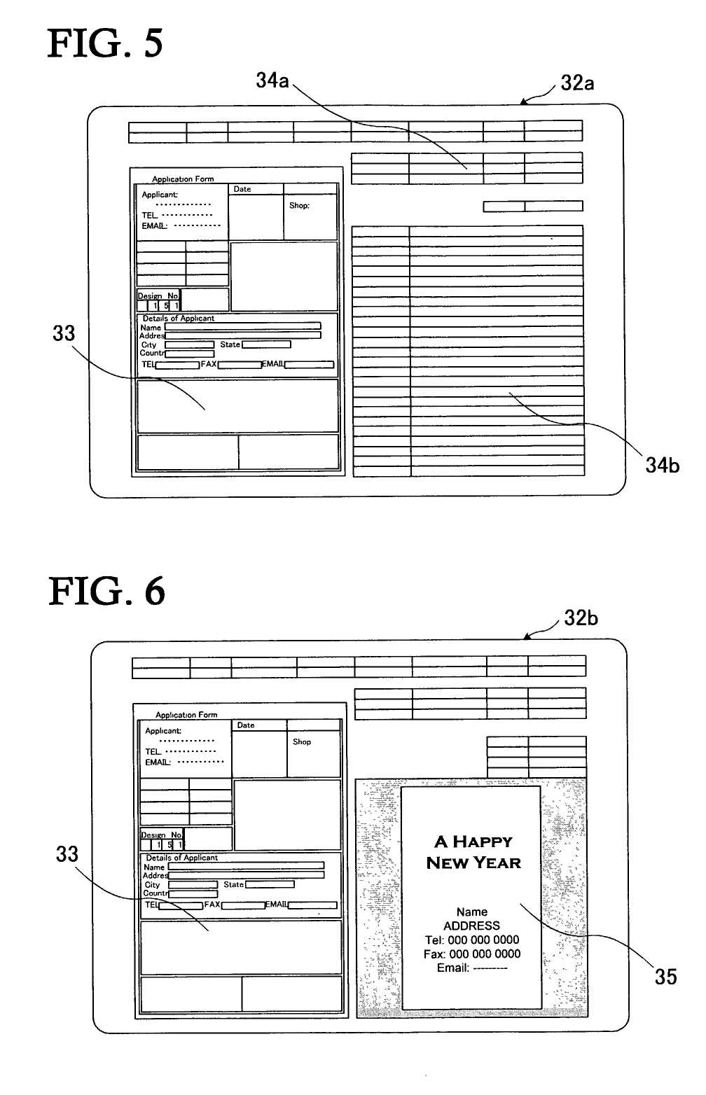

FIG. 5 illustrates an example of a work screen 22. The application form display part 23 indicated with image corresponding the contents of the application form 12 given from the data read by the scanner 21 is displayed on a half of the screen, preferably a half space of the screen, and an input part 24 is displayed on the remaining space of the screen. The operator inputs the contents of an application into the input part 24, looking at the application form display part 23. Under the present circumstances, although the operator may input and edit to the information into the input part 24 by hand, some parts or predetermined parts are automatically inputted using an OCR function respectively. As contents using an OCR function, a postal code number is one of examples. Furthermore, the address is automatically acquired from the postal code number using a postal code number correspondence function. The address is indicated the contents except the address code so that it is inputted by hand. Moreover, store code, image design code, and text pattern code 17 and so on may be automatically acquired by the OCR function respectively.

After inputting, the work screen 22 is changed to a layout display part 25, and the operator checks the contents. The half of the layout display part 25 shows the application form display part 23, and the design pattern, text pattern 18, individual specification information, etc. are displayed on the layout display part 25 as a completion state.

The operator compares the contents of the application form display part 23 with that of the layout display part 25, and checks whether there is any error in the contents of an input or not When there is the input mistake, it is corrected by returning to the work screen 22. If the final check ends, the completion data is stored into the order management database 5 of the management server 2 by the operator. Then, the completion data or notice of completion may be transmitted by using the facsimile 10, telephone, terminal or the like to the store.

In addition, it can also check automatically whether there is any error in the contents of an input of the application form display part 23 and the layout display part 25 through a control part.

When the store receives the notice of completion, an operator of the store accesses the management server 2, detects completion data identifying to the order number, and receives at the terminal 1 for printing. Although you may carry out by the operation from the terminal 1 for printing about this reception, transmitting to the terminal 1 for printing beforehand is also considered using the control part of the manufacture terminal 3 or the management server 2.

At the terminal 1 for printing, the operator checks, is whether there is a mistake or problem in the outputted contents displayed as a completion state on the screen of a printing check screen 26 using the program for printing. Then, in the program for printing, the various codes of the completion data transmitted is allowed to correspond with the various databases, changed to the corresponding data, and is displayed based as an output data.

If the contents are correct, the printer 11 using the terminal 1 for printing prints New Year's card of the required number of sheets.

When the contents are something wrong, the notice of correction is transmitted to the manufacture center by the file transmission using the facsimile 10, telephone, terminal, etc., and, it is operated to print in the same procedure as above after correcting at the manufacture terminal 3.

In addition, although the manufacturing the New Year's greeting card as the greeting card is explained in this embodiment of the present invention, Christmas card, in-mourning postcard, invitation card, a card and so on including an individual's specific information, cards, including a specific company information, including a transfer guidance, festival guidance, commencement-of-business guidance, direct mail, etc. may be manufactured

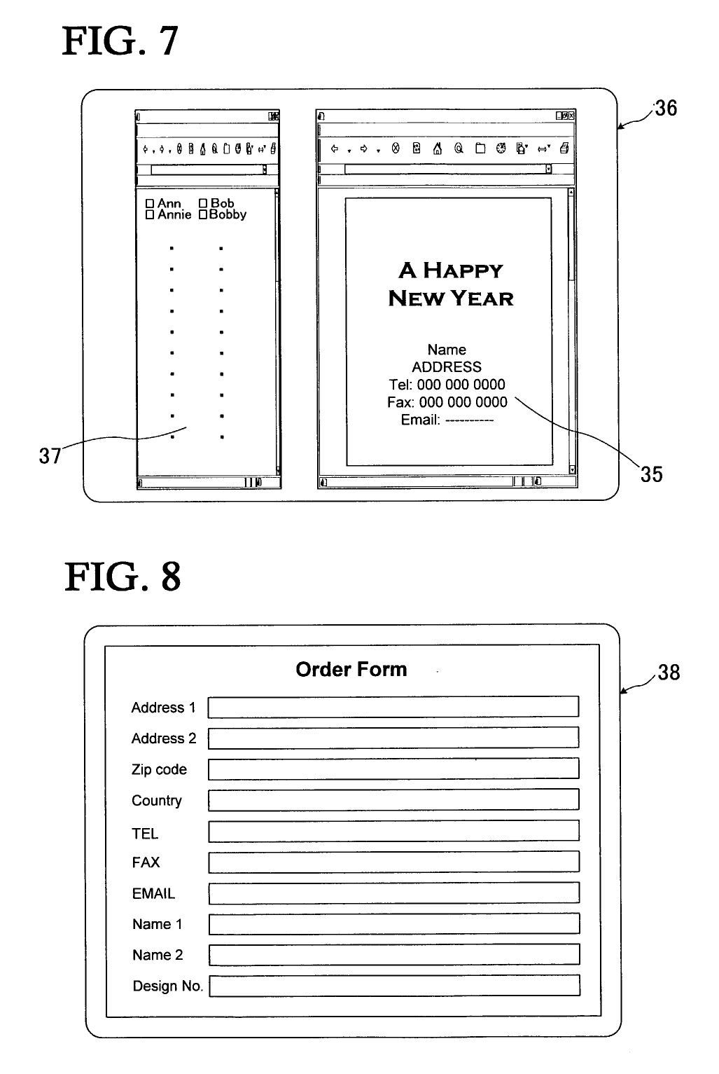

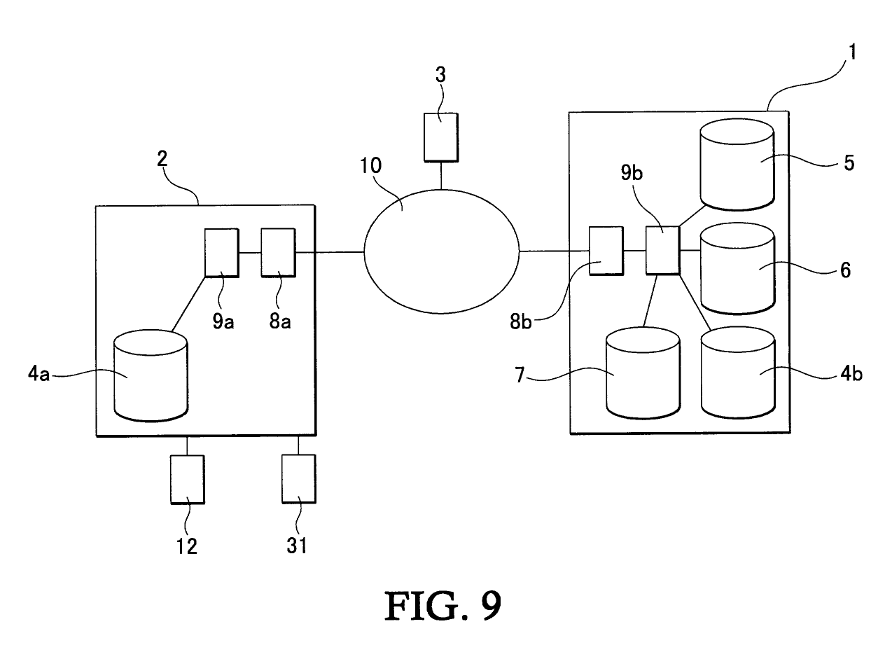

Other embodiments of the present invention will now be described referring to FIGS. 7 to 9. Through the drawings of the embodiments, like components are denoted by like numerals as of the first embodiment and will not be further explained in great detail.

A second embodiment of the present invention is shown in FIGS. 7 to 9. It is distinguished from the first embodiment by the fact that the facsimile 10 and a scanner 21 are not used in the manufacture center.

In this case, the receiving device which receives the transmitting data from the facsimile 10 is installed into the management server 2, and the application information is stored and managed at an application management database. The same work is done using this arrangement In addition, in this system, the applicant may not use the facsimile arranged at the receptionist store as a facsimile 10 for application form transmission and may uses facsimile which the customer has. In this case, the customer may apply without going to the store, the store can receive after the set time and the customer can save a time to wait at the store.

Moreover, the goods may be offered due to exclude renewal proceeding by accumulating completion data in the order management database 5 of the management server 2 when there is additional order later.

Furthermore, although each embodiment differs mainly explained based on the first embodiment, even if it uses the present invention combining the composition used for the form of not only this but each embodiment, the same action effect is acquired.

As set forth above, the advantages of the invention are as follows:

(1) A system for manufacturing an ordered card includes a transmitting equipment reads and transmit an application form; a receiving equipment receives application information from the transmitting equipment; a management server including a database for image data which manages an image code corresponding to specific image patterns including a design and a pattern arranged on an ordered card; a customer database; and an order management database which manages a data for transmission replaced image pattern data to the image code after creating a layout data which manufactured the layout of the ordered card based on the information from a customer; a manufacture terminal for the ordered card installed into the management server connectably; a terminal for printing connected to the management server, having the database for image data and means for checking, receiving a data for transmission from the order management database of the management server and displaying a printing layout picture based on a layout data which is changed from the image code to the image pattern; and a printing machine connected to the terminal for printing since the terminal for printing and management server have the database for image data, and the image data with many amounts of data are changed to data into the image code with the few amount of data and transmitted and received, the exchange of data can be performed efficiently.

(2) As discussed above, since data for printing include all data containing image data, it is unnecessary to prepare the post card which is printed the image design beforehand, and decreasing the number of stock, reduction of a receipt place, and reduction of the loss caused by unnecessary stock can be performed effectively.

What is claimed is:

1. A system for manufacturing an ordered card comprising:
a transmitting equipment reads and transmit an application form;
a receiving equipment receives application information from the transmitting equipment;
a management server including a database for image data which manages an image code corresponding to specific image patterns including a design and a pattern arranged on an ordered card; a customer database; and an order management database which manages a data for transmission replaced image pattern data to the image code after creating a layout data which manufactured the layout of the ordered card based on the information from a customer;
a manufacture terminal for the ordered card installed into the management server connectably;
a terminal for printing connected to the management server, having the database for image data and means for checking, receiving a data for transmission from the order management database of the management server and displaying a printing layout picture based on a layout data which is changed from the image code to the image pattern; and
a printing machine connected to the terminal for printing.

2. A system for manufacturing an ordered card according to claim 1, further comprising;
the receiving equipment is installed into the management server; and
the management database including an application management database stores and manages the application information.

3. A system for manufacturing an ordered card according to any one of claim 1 and 2, wherein the receiving equipment further includes an OCR function, obtaining automatically the contents of application information.

4. A system for manufacturing an ordered card according to any one of claim 1 and 2, wherein the application form includes an entry column of individual specification information and an image pattern specification column which specifies the image code applicable to specific image patterns including a design and a pattern matched for the ordered card.
